(19) United States
(12) Patent Application Publication
(10) Pub. No.: US 2007/0009268 A1
(43) Pub. Date: Jan. 11, 2007

(54) System and method for transmitting data in a video signal by modulating a video signal brightness level

(75) Inventor: Demetri Giannopoulos, Norwalk, CT (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/573,748

(22) PCT Filed: Sep. 27, 2004
(86) PCT No.: PCT/IB04/51880

§ 371 Date: Mar. 28, 2006

Related U.S. Application Data
(60) Provisional application No. 60/506,884, filed on Sep. 29, 2003.

(51) Int. Cl. H04B 10/04; G02B 26/00

(52) U.S. Cl. 398/183; 359/238

(57) ABSTRACT

A system and method is provided for transmitting data in a video signal by modulating a brightness level of the video signal. The invention comprises a video display unit that is capable of encoding data into a brightness level of a video signal and creating brightness modulated video images for display on a display screen. The invention also comprises a brightness modulated data receiver unit that is capable of receiving the brightness modulated video images from the display screen and decoding the data that is encoded in the brightness modulated video images. The modulation of the brightness level of the video signal is adjusted so that changes in the brightness level of the video signal are not perceptible to human vision.

The present invention is directed, in general, to audio-visual systems and, more specifically, to a system and method for transmitting data in a video signal by modulating a brightness level of the video signal.

Video displays have traditionally been used to display video images and text. Video displays such as liquid crystal display (LCD) monitors and televisions typically comprise a light source, one or more active matrix panels, and a display screen. Light that is generated in the light source is modulated by the active matrix panels. An electronic circuit controls the pixels in the active matrix panels to modulate the light that is output by the light source. The resulting video image is displayed on the display screen. Display controls that are associated with the display screen allow a user to manually adjust several of the display parameters that affect the image. One of the display parameters that may be manually adjusted by a user is the brightness level of the displayed image.

There is a need in the art for a system and method that is capable of transmitting data in a video signal by modulating a display parameter of a video signal. In particular, there is a need in the art for a system and method that is capable of transmitting data in a video signal by modulating a brightness level of the video signal.

The system and method of the present invention is capable of transmitting data in a video signal by modulating a brightness level of the video signal. Modulating the brightness level of the video signal enables the transmission of data in addition to the data that is transmitted in the audio portions and the video portions of the video signal.

The brightness level modulation is performed at a high frequency so that the changes in the brightness level are imperceptible to human vision. The human eye integrates the brightness levels of a video display. Therefore the viewer will perceive only the average brightness of the modulated brightness levels. However, high frequency transitions between high brightness levels and low brightness levels can be detected by an optical receiver.

A video display unit of the present invention encodes an input data stream in a video signal by adjusting the brightness levels of the video signal. The resulting brightness modulated video images are displayed on a display screen. An optical receiver in a brightness modulated data receiver unit detects the changes in the brightness level of the video signal and outputs a signal that represents the brightness modulated data. The brightness modulated data is processed in a brightness modulated data processor unit to recreate the original data stream that was encoded in the video signal. The data stream that is encoded in the video signal may be a data stream that represents an audio output, a text output, or a video output.

The video display unit of the invention comprises a brightness level modulating panel that is capable of receiving a data stream and modulating a brightness level of a video signal to encode the data stream into the brightness level of the video signal. The brightness level modulating panel modulates the brightness level of the video signal during a data transmission period between two row refreshing periods of the video signal.

The brightness level modulating panel is capable of encoding one type of data bit (e.g., bit “0”) during a data transmission period by setting the brightness level of the video signal to a maximum level during a first portion of the data transmission period and by setting the brightness level of the video signal to a minimum level during a second portion of the data transmission period. By setting the brightness level of the video signal to a minimum level during the first portion of the data transmission period and by setting the brightness level of the video signal to a maximum level during a second portion of the data transmission period, the brightness level modulating panel is capable of encoding one other type of data bit (e.g., bit “1”).

It is an object of the present invention to provide a system and method for transmitting data in a video signal by modulating a brightness level of the video signal.

It is another object of the present invention to provide a system and method for transmitting data in a video signal by modulating a brightness level of the video signal during a data transmission period between two row refreshing periods of the video signal.

It is also an object of the present invention to provide a video display unit that is capable of encoding a data stream into a brightness level of a video signal to create brightness modulated data images for display that contain the encoded data stream within the brightness level of the video signal.

It is another object of the present invention to provide a brightness modulated data receiver unit that is capable of receiving the brightness modulated data images that are created by the video display unit and decoding the data stream that is encoded within the brightness modulated data images.

It is also an object of the present invention to provide a system and method for transmitting data in a video signal by modulating a brightness level of the video signal in a manner that causes the modulation of the brightness level of the video signal to be imperceptible to human vision.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

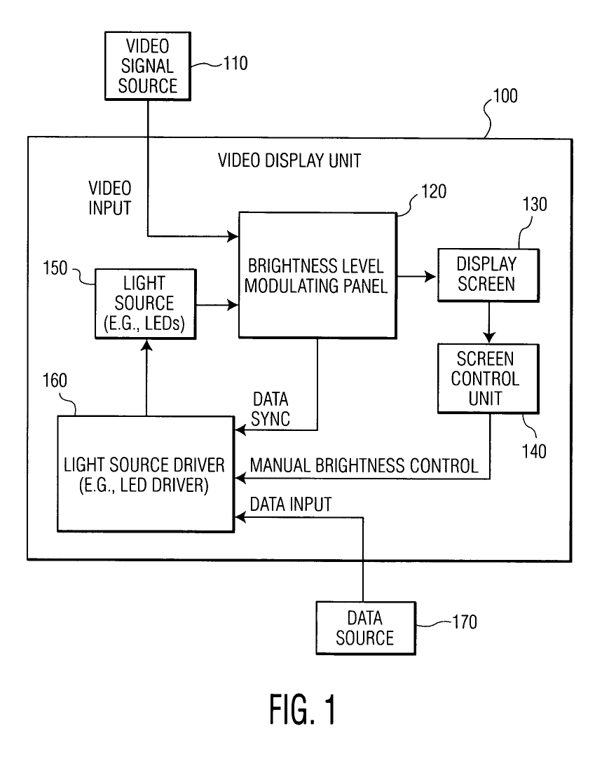

FIG. 1 is a block diagram that illustrates an advantageous embodiment of a video display unit and a brightness level modulating panel in accordance with the principles of the present invention;

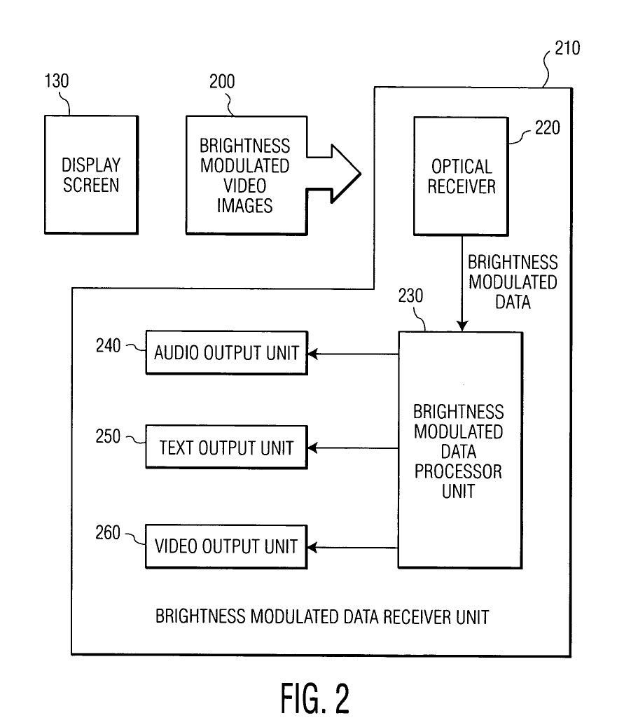

FIG. 2 is a block diagram that illustrates an advantageous embodiment of a brightness modulated data receiver unit and an optical receiver in accordance with the principles of the present invention;

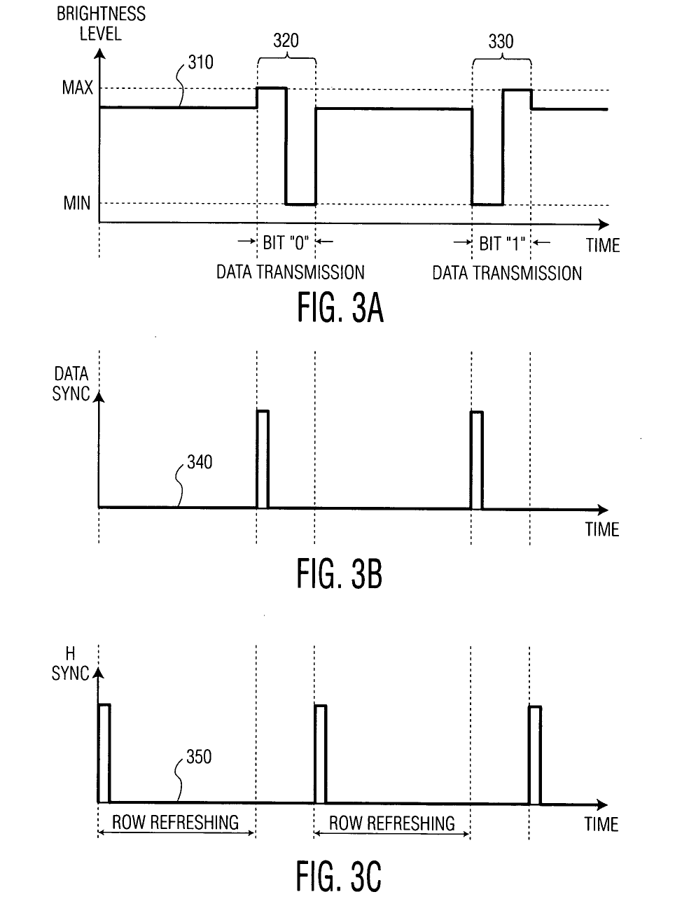

FIG. 3(a) is a diagram that illustrates an exemplary brightness level of a video signal in accordance with an advantageous embodiment of a bi-phase amplitude modulation method of the invention;

FIG. 3(b) is a diagram that illustrates an exemplary data sync signal in accordance with an advantageous embodiment of a bi-phase amplitude modulation method of the invention;

FIG. 3(c) is a diagram that illustrates an exemplary horizontal sync signal in accordance with an advantageous embodiment of a bi-phase amplitude modulation method of the invention;

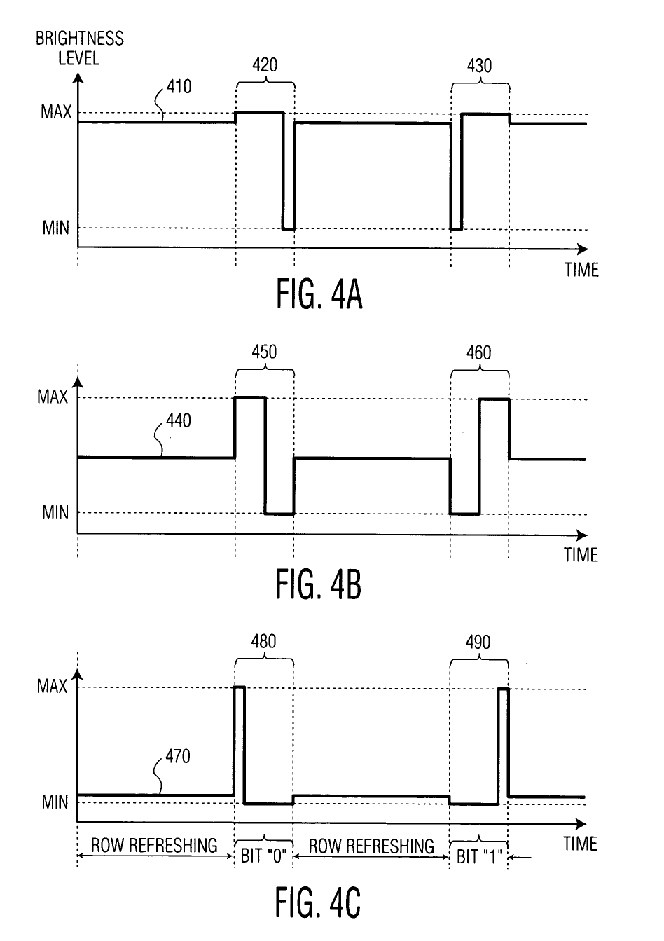

FIG. 4(a) is a diagram that illustrates a first exemplary brightness level of a video signal in accordance with an advantageous embodiment of an asymmetric bi-phase amplitude modulation method of the present invention;

FIG. 4(b) is a diagram that illustrates a second exemplary brightness level of a video signal in accordance with an advantageous embodiment of an asymmetric bi-phase amplitude modulation method of the present invention;

FIG. 4(c) is a diagram that illustrates a third exemplary brightness level of a video signal in accordance with an advantageous embodiment of an asymmetric bi-phase amplitude modulation method of the present invention;

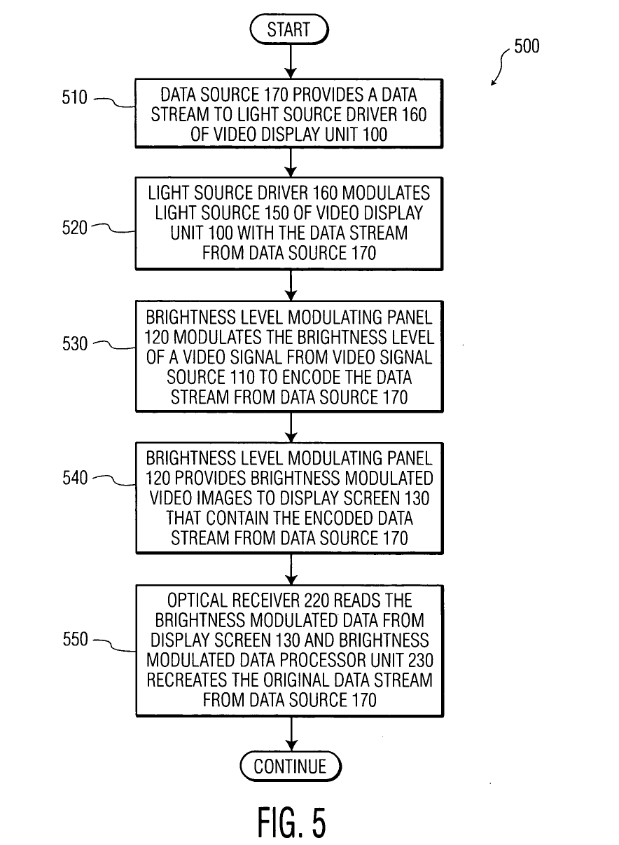

FIG. 5 illustrates a flowchart showing the steps of an advantageous embodiment of a first portion of the method of the invention;

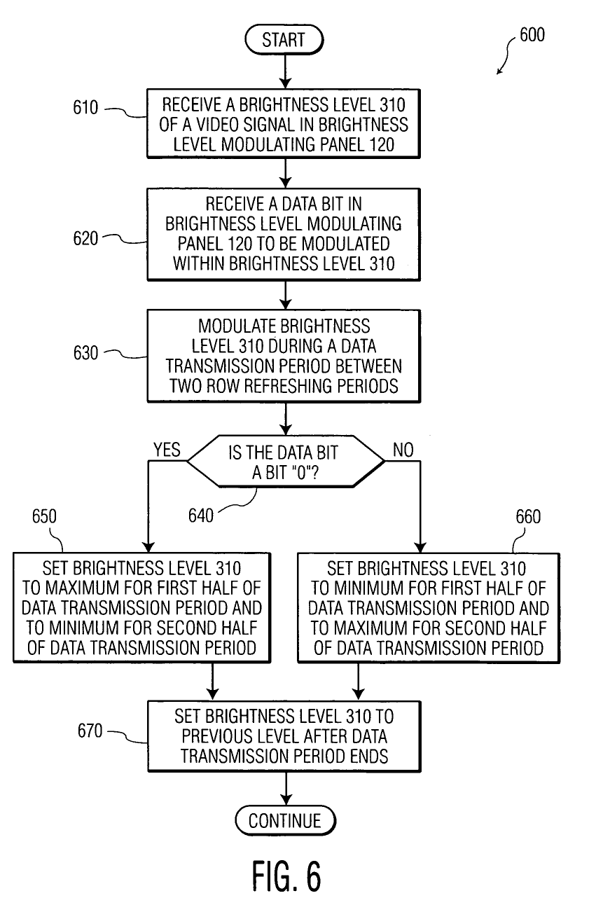

FIG. 6 illustrates a flowchart showing the steps of an advantageous embodiment of a second portion of the method of the invention;

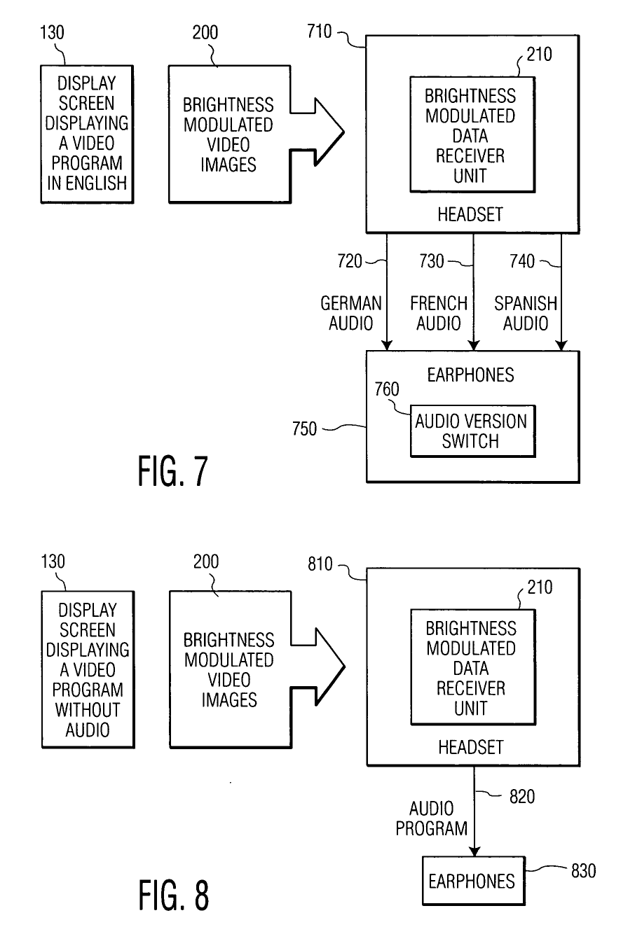

FIG. 7 is a diagram that illustrates the use of the present invention in a headset that provides a plurality of audio programs in different foreign languages; and

FIG. 8 is a diagram that illustrates the use of the present invention in a headset that provides an audio program for a video program that is displayed without an audio program.

FIGS. 1 through 8, discussed below, and the various embodiments used to describe the principles of the present invention in this patent document are by way of illustration only and should not be construed in any way to limit the scope of the invention. The present invention may be used in any suitable audio-visual system.

FIG. 1 is a block diagram that illustrates an advantageous embodiment of a video display unit 100 and a brightness level modulating panel 120 in accordance with the principles of the present invention. Video display unit 100 receives video signals from a video signal source 110. The video signals from video signal source 110 are provided as a first input to brightness level modulating panel 120. Video display unit 100 also comprises a light source 150 and a light source driver 160. Light source 150 may comprise, for example, light emitting diodes (LEDs). Light source driver 160 may comprise, for example, a light emitting diode (LED) driver. The output of light source 150 is provided as a second input to brightness level modulation panel 120.

A data stream from data source 170 (designated DATA INPUT) is provided to light source driver 160. Light source driver 160 modulates light source 150 in accordance with the data stream from data source 170. Brightness level modulating panel 120 then modulates the brightness level of the video signal from video signal source 110 to encode the data stream from data source 170. The brightness modulated video images are then output to display screen 130 and the video images are presented for viewing. Display screen 130 may comprise any conventional type of display screen (e.g., television, computer monitor, flat panel display screen).

Brightness level modulating panel 120 provides a data synchronization signal (designated DATA SYNC) to light source driver 160. In addition, a screen control unit 140 coupled to display screen 130 provides a manual brightness control signal (designated MANUAL BRIGHTNESS CONTROL) to light source driver 160. If a viewer of display screen 130 manually changes the brightness level of the images displayed on display screen 130, then the change in brightness level will be communicated to light source driver 160. Light source driver 160 will then adjust the brightness level of light source 150 accordingly.

FIG. 2 is a block diagram that illustrates an advantageous embodiment of a brightness modulated data receiver unit 210 and an optical receiver 220 in accordance with the principles of the present invention. Brightness modulated video images 200 from display screen 130 are incident on optical receiver 220. As previously mentioned, optical receiver 220 detects the changes in the brightness level of the video signal in the brightness modulated video images 200. Optical receiver 220 outputs a signal that represents the brightness modulated data to brightness modulated data processor unit 230. Brightness modulated data processor unit 230 processes the brightness modulated data to re-create the original data stream from data source 170 that was encoded in the video signal by brightness level modulating panel 120.

Brightness modulated data processor unit 230 decodes audio data from the brightness modulated data and provides the audio data to audio output unit 240. Alternatively, brightness modulated data processor unit 230 decodes text data from the brightness modulated data and provides the text data to text output unit 250. Alternatively, brightness modulated data processor unit 230 decodes video data from the brightness modulated data and provides the video data to video output unit 260.

FIGS. 3(a)-3(c) are diagrams that illustrates an exemplary brightness level 310 of a video signal, a data sync signal 340 and a horizontal sync signal 350 (designated H SYNC 350) in accordance with an advantageous embodiment of the invention. The magnitude of brightness level 310 and the magnitude of data sync signal 340 and the magnitude of horizontal sync signal 350 are shown as a function of time.

As shown in FIGS. 3(a)-3(c), data transmission periods of the present invention are located in between row refreshing periods. In prior art systems no data is transmitted during the time between the row refreshing periods. During a row refreshing period the pixels in the display that correspond to an entire row are refreshed. In the present invention exemplary data transmission period 320 and exemplary data transmission period 330 are located between row refreshing periods. Modulating the brightness level 310 during the data transmissionperiods (320, 330) enablesoneormore bits to be transmitted.

FIG. 3(a) illustrates an advantageous embodiment of a method of the invention in which one (1) bit is transmitted during each data transmission period. In the advantageous embodiment shown in FIG. 3(a), during data transmission period 320 a signal that represents a bit “0” is transmitted. The bit “0” signal comprises a first one half of the transmission period 320 in which the brightness level 310 is at a maximum allowable level (designated MAX) and a second one half of the transmission period 320 in which the brightness level 310 is at a minimum allowable level (designated MIN). After the data transmission period 320 has ended, the brightness level returns to the brightness level that existed before the beginning of data transmission period 320.

In the advantageous embodiment shown in FIG. 3(a), during data transmission period 330 a signal that represents a bit “1” is transmitted. The bit “1” signal comprises a first one half of the transmission period 330 in which the brightness level 310 is at a minimum allowable level (designated MIN) and a second one half of the transmission period 330 in which the brightness level 310 is at a maximum allowable level (designated MAX). After the data transmission period 330 has ended, the brightness level returns to the brightness level that existed before the beginning of data transmission period 330.

In the example shown in FIG. 3(a), the representation of a bit “0” corresponds to a “high-to-low” transition from the maximum value of brightness to the minimum value of brightness. The representation of a bit “1” corresponds to a “low-to-high” transition from the minimum value of brightness to the maximum value of brightness. The transitions between the maximum and minimum brightness levels facilitate the detection of the transitions by optical receiver 220. The data synchronization signal 340 signals the beginning of each data transmission period. Similarly, the horizontal synchronization signal 350 signals the beginning of each row refreshing period.

It is understood that the modulation patterns for bit “0” and for bit “1” shown in FIG. 3(a) are merely examples. Other types of modulation patterns might be employed to represent bit “0” and to represent bit “1” during the data transmission periods (320, 330). In addition, it is understood that the example of transmitting one bit per data transmission period is also merely an example. In alternate embodiments of the present invention, more than one bit may be transmitted during a data transmission period.

There should be no perceptible brightness variation for a human viewer for any brightness modulated data pattern. This requires that the average value of the modulated brightness data pattern during the transmission of a bit “0” data bit be equal to the average value of the modulated brightness data pattern during the transmission of a bit “1” data bit. Arranging the brightness modulated data patterns so that the average value of the modulated brightness data pattern is the same for each bit that is transmitted may be referred to as “bi-phase amplitude modulation.”

FIGS. 4(a)-4(c) are diagrams that illustrate three exemplary brightness levels (410, 440, 470) of a video signal in accordance with an advantageous embodiment of an asymmetric bi-phase amplitude modulation method of the present invention. In FIG. 4(a) the brightness level 410 during a row refreshing period has a high value. That is, the brightness level 410 is relatively near the maximum allowable level MAX. In order to maintain an average value of the modulated brightness data pattern during data transmission period 420 that is approximately equal to the brightness level 410 during a row refreshing period, a first portion of the data transmission period 420 (in which the brightness level 410 is at a maximum allowable level MAX) is longer in duration than a second portion of the data transmission period 420 (in which the brightness level 410 is at a minimum allowable level MIN).

Similarly, in order to maintain an average value of the modulated brightness data pattern during data transmission period 430 that is approximately equal to the brightness level 410 during a row refreshing period, a first portion of the data transmission period 430 (in which the brightness level 410 is at a minimum allowable level MIN) is shorter in duration than a second portion of the data transmission period 430 (in which the brightness level 410 is at a maximum allowable level MIN).

The length of time of a first portion of a data transmission period and the length of time of a second portion of the data transmission period are adjusted so that the average value of the modulated brightness data pattern during the data transmission period is approximately equal to the value of the brightness level during a row refreshing period. Adjusting the relative lengths of the first and second portions of a brightness modulated data pattern so that the average value of the modulated brightness data pattern during the data transmission period is approximately equal to the value of the brightness level during a row refreshing period may be referred to as “asymmetric bi-phase amplitude modulation.”

Asymmetric bi-phase amplitude modulation may be used to minimize any reduction in the maximum display brightness that may be caused by brightness level modulation during the data transmission periods. Asymmetric bi-phase amplitude modulation may also be used to minimize any increase in the minimum display brightness that may be caused by brightness level modulation during the data transmission periods

In FIG. 4(b) the brightness level 440 during a row refreshing period has a medium value. That is, the brightness level 440 is approximately halfway between the minimum allowable level MIN and the maximum allowable level MAX. In order to maintain an average value of the modulated brightness data pattern during data transmission period 450 that is approximately equal to the brightness level 440 during a row refreshing period, a first portion of the data transmission period 450 (in which the brightness level 440 is at a maximum allowable level MAX) is approximately equal in duration to a second portion of the data transmission period 450 (in which the brightness level 440 is at a minimum allowable level MIN).

Similarly, in order to maintain an average value of the modulated brightness data pattern during data transmission period 460 that is approximately equal to the brightness level 440 during a row refreshing period, a first portion of the data transmission period 460 (in which the brightness level 440 is at a minimum allowable level MIN) is approximately equal in duration to a second portion of the data transmission period 460 (in which the brightness level 440 is at a maximum allowable level MIN).

In FIG. 4(c) the brightness level 470 during a row refreshing period has a low value. That is, the brightness level 470 is relatively near the minimum allowable level MIN. In order to maintain an average value of the modulated brightness data pattern during data transmission period 480 that is approximately equal to the brightness level 470 during a row refreshing period, a first portion of the data transmission period 480 (in which the brightness level 470 is at a maximum allowable level MAX) is shorter in duration than a second portion of the data transmission period 480 (in which the brightness level 470 is at a minimum allowable level MIN).

Similarly, in order to maintain an average value of the modulated brightness data pattern during data transmission period 490 that is approximately equal to the brightness level 470 during a row refreshing period, a first portion of the data transmission period 490 (in which the brightness level 470 is at a minimum allowable level MIN) is longer in duration than a second portion of the data transmission period 490 (in which the brightness level 470 is at a maximum allowable level MIN).

FIG. 5 illustrates a flowchart showing the steps of an advantageous embodiment of a first portion of the method of the invention. The steps of the method shown in FIG. 5 are collectively referred to with reference numeral 500. In the first step shown in FIG. 5, data source 170 provides a data stream to light source driver 160 of video display unit 100 (step 510). Then light source driver 160 modulates light source 150 of video display unit 100 with the data stream from data source 170 (step 520). Brightness level modulating panel 530 modulates the brightness level of a video signal from video signal source 110 in order to encode the data stream from data source 170 (step 530). The brightness modulated video images from brightness level modulating panel 120 contain the encoded data stream from data source 170. Brightness level modulating panel 120 then provides the brightness modulated video images to display screen 130 (step 540). Optical reader 220 in brightness modulated data receiver unit 210 reads the brightness modulated data from the display screen 130 and brightness modulated data processor unit 230 recreates the original data stream from data source 170 (step 550).

FIG. 6 illustrates a flowchart showing the steps of an advantageous embodiment of a second portion of the method of the invention. The steps of the method shown in FIG. 6 are collectively referred to with reference numeral 600. In the first step shown in FIG. 6, brightness level modulating panel 120 receives a brightness level 310 of a video signal (step 610). Brightness level modulating panel 120 also receives a data bit to be modulated within brightness level 310 (step 620). Brightness level modulating panel 120 modulates brightness level 310 during a data transmission period between two row refreshing periods (step 630). Brightness level modulating panel 120 determines whether the data bit to be encoded is a bit “0” data bit (decision step 640).

If the data bit to be encoded is a bit “0” data bit, then brightness level modulating panel 120 sets the brightness level 310 to the maximum level MAX for the first half of data transmission period and to the minimum level MIN for the second half of the data transmission period (step 650). Then brightness level modulating panel 120 sets the brightness level 310 to its previous brightness level after the data transmission period ends (step 670).

If the data bit to be encoded is not a bit “0” data bit, then it is a bit “1” data bit. In that case, brightness level modulating panel 120 sets the brightness level 310 to the minimum level MIN for the first half of data transmission period and to the maximum level MAX for the second half of the data transmission period (step 660). Then brightness level modulating panel 120 sets the brightness level 310 to its previous brightness level after the data transmission period ends (step 670).

The system and method of the present invention may be used in numerous applications. For example, FIG. 7 illustrates an advantageous application in which the invention is capable of receiving and playing audio signals that represent different languages. Display screen 130 displays a video program in which the audio portion is in English. Audio data streams that represent an audio portion in German, and audio portion in French, and an audio portion in Spanish have been encoded in the brightness modulated video images 200. Brightness modulated data receiver 210 of the present invention may be associated with a headset 710 to receive and decode the brightness modulated audio data streams in the brightness modulated video images 200. Optical reader 220 (not shown in FIG. 7) reads the encoded audio data streams and brightness modulated data processor unit 230 (not shown in FIG. 7) decodes the encoded audio data streams to recover the foreign language audio portions.

Brightness modulated data receiver unit 210 in headset 710 provides the German audio signal 720, and the French audio signal 730, and the Spanish audio signal 740 to earphones 750. The user selects the desired audio signal using audio version switch 760. This advantageous embodiment of the present invention may be used in any type of audio-visual presentation in which the audience is made up of persons who do not speak the same language.

FIG. 8 illustrates an advantageous application in which the invention is capable of receiving and playing an audio program for a video program that is displayed without an audio program. This type of display may occur during the presentation of movies during an airplane flight. In the prior art, it is necessary for the user to plug a headset into an audio outlet plug near the user in order to head the audio program that relates to the video program. The present invention does not need to employ an audio outlet plug. The present invention is capable of obtaining the audio program from brightness modulated video images.

Display screen 130 displays a video program in which the corresponding audio program is not audibly transmitted. An audio data stream that represents the corresponding audio program has been encoded in the brightness modulated video images 200. Brightness modulated data receiver 210 of the present invention may be associated with a headset 810 to receive and decode the brightness modulated audio data stream in the brightness modulated video images 200. Optical reader 220 (not shown in FIG. 8) reads the encoded audio data streams and brightness modulated data processor unit 230 (not shown in FIG. 8) decodes the encoded audio data stream to recover the corresponding audio program.

Brightness modulated data receiver unit 210 in headset 810 provides the audio program signal 820 to earphones 830 for the user. This advantageous embodiment of the present invention may be used in any type of audio-visual presentation in which an audio program is not presented with its corresponding video program.

While the present invention has been described in detail with respect to certain embodiments thereof, those skilled in the art should understand that they can make various changes, substitutions modifications, alterations, and adaptations in the present invention without departing from the concept and scope of the invention in its broadest form.

1. An apparatus (100,210) that transmits data (320,330) in a video signal by modulating a brightness level (310) of said video signal.

2. An apparatus (100,210) as claimed in claim 1 wherein said apparatus modulates said brightness level (310) of said video signal during a data transmission period between two row refreshing periods of said video signal.

3. An apparatus (100,210) as claimed in claim 1 wherein said apparatus comprises:
a video display unit that is capable of encoding said data (320,330) into said brightness level (310) of said video signal to create brightness modulated video images (200); and
a brightness modulated data receiver unit (210) that is capable of receiving said brightness modulated video images (200) and decoding said data (320,330) from said brightness modulated video images (200).

4. An apparatus (100,210) as claimed in claim 3 wherein said video display unit comprises a brightness level modulating panel (120) that is capable of modulating said brightness level (310) of said video signal to encode said data (320,330) into said brightness level (310) of said video signal.

5. An apparatus (100,210) as claimed in claim 3 wherein said brightness modulated data receiver unit (210) comprises:
an optical receiver (220) that is capable of receiving said brightness modulated video images (200) from said video display unit (100) and detecting changes in said brightness level (310) of said video signal that represent said data (320,330) that is encoded into said brightness level (310) of said video signal; and
a brightness modulated data processor unit (230) that is capable of decoding said data (320,330) from said brightness modulated video images that are detected by said optical receiver (220).

6. An apparatus (100,210) as claimed in claim 5 wherein said brightness modulated data processor unit (230) decodes said data (320,330) from said brightness modulated video images (200) to recreate one of: an audio output, a text output, and a video output.

7. An apparatus (100,210) as claimed in claim 3 wherein said brightness level modulating panel (120) modulates said brightness level (310) of said video signal to encode at least one bit (320) of said data (320,330) into said brightness level (310) of said video signal in a data transmission period between two row refreshing periods of said video signal.

8. An apparatus (100,210) as claimed in claim 7 wherein said brightness level modulating panel (120) modulates said brightness level (310) of said video signal using one of: bi-phase amplitude modulation and asymmetric bi-phase amplitude modulation.

9. An apparatus (100,210) as claimed in claim 3 wherein said data that said video display unit (100) encodes into said brightness level (310) of said video signal to create brightness modulated video images (200) comprises at least one foreign language audio program; and
wherein said data that said brightness modulated data receiver unit (210) receives and decodes from said brightness modulated video images (200) comprises said at least one foreign language audio program.

10. An apparatus (100,210) as claimed in claim 3 wherein said data that said video display unit (100) encodes into said brightness level (310) of said video signal to create brightness modulated video images (200) comprises an audio program for a video program for which said audio program is not audibly transmitted; and
wherein said data that said brightness modulated data receiver unit (210) receives and decodes from said brightness modulated video images (200) comprises said audio program for said video program for which said audio program is not audibly transmitted.

11. A method for transmitting data (320,330) in a video signal, said method comprising the step of modulating a brightness level (310) of said video signal.

12. The method as claimed in claim 11 further comprising the step of:
modulating said brightness level (310) of said video signal during a data transmission period between two row refreshing periods of said video signal.

13. The method as claimed in claim 11 further comprising the steps of:
encoding said data (320,330) into said brightness level (310) of said video signal in a video display unit (100) to create brightness modulated video images (200);
receiving said brightness modulated video images (200) in a brightness modulated data receiver unit (210); and
decoding said data (320,330) from said brightness modulated video images (200).

14. The method as claimed in claim 13 further comprising the step of:
modulating said brightness level (310) of said video signal in a brightness level modulating panel (120) of said video display unit (100) to encode said data (320,330) into said brightness level (310) of said video signal.

15. The method as claimed in claim 13 further comprising the steps of:
receiving said brightness modulated video images (200) from said video display unit (100) in an optical receiver (220);
detecting in said optical receiver (220) changes in said brightness level (310) of said video signal that represent said data (320,330) that is encoded into said brightness level (310) of said video signal; and
decoding in a brightness modulated data processor unit (230) said data from said brightness modulated video images (200) that are detected by said optical receiver (220).

16. The method as claimed in claim 15 further comprising the step of:
decoding said data (320,330) from said brightness modulated video images (200) to recreate one of: an audio output, a text output, and a video output.

17. The method as claimed in claim 13 further comprising the step of:
modulating said brightness level (310) of said video signal to encode at least one bit (320) of said data (320,330) into said brightness level (310) of said video signal in a data transmission period between two row refreshing periods of said video signal.

18. The method as claimed in claim 17 further comprising the step of:
modulating said brightness level (310) of said video signal using one of: bi-phase amplitude modulation and asymmetric bi-phase amplitude modulation.

19. The method as claimed in claim 13 further comprising the steps of:
encoding data (320,330) that comprises at least one foreign language audio program into said brightness level (310) of said video signal to create brightness modulated video images (200);
receiving said brightness modulated video images (200); and
decoding from said brightness modulated video images (200) said data that comprises said at least one foreign language audio program.

20. The method as claimed in claim 13 further comprising the steps of:
encoding data (320,330) that comprises an audio program for a video program for which said audio program is not audibly transmitted into said brightness level (310) of said video signal to create brightness modulated video images (200);
receiving said brightness modulated video images (200); and
decoding from said brightness modulated video images (200) said data (320,330) that comprises said audio program for said video program for which said audio program is not audibly transmitted.

21. An encoded video signal (310) generated by a method for transmitting data (320,330) in a video signal, said method comprising the step of modulating a brightness level (310) of said video signal.

22. An encoded video signal (310) as claimed in claim 21 wherein said method further comprises the step of:
modulating said brightness level (310) of said video signal during a data transmission period between two row refreshing periods of said video signal.

23. An encoded video signal (310) as claimed in claim 21 wherein said method further comprises the steps of:
encoding said data (320,330) into said brightness level (310) of said video signal in a video display unit (100) to create brightness modulated video images (200);
receiving said brightness modulated video images (200) in a brightness modulated data receiver unit (210); and
decoding said data (320,330) from said brightness modulated video images (200).

24. An encoded video signal (310) as claimed in claim 23 wherein said method further comprises the step of:
modulating said brightness level (310) of said video signal in a brightness level modulating panel (120) of said video display unit (100) to encode said data (320, 330) into said brightness level (310) of said video signal.

25. An encoded video signal (310) as claimed in claim 23 wherein said method further comprises the steps of:
receiving said brightness modulated video images (200) from said video display unit (100) in an optical receiver (220);
detecting in said optical receiver (220) changes in said brightness level (310) of said video signal that represent said data 320,330) that is encoded into said brightness level (310) of said video signal; and
decoding in a brightness modulated data processor unit (230) said data (320,330) from said brightness modulated video images that are detected by said optical receiver.

26. An encoded video signal as claimed in claim 25 wherein said method further comprises the step of:
decoding said data from said brightness modulated video images to recreate one of: an audio output, a text output, and a video output.

27. An encoded video signal as claimed in claim 23 wherein said method further comprises the step of:
modulating said brightness level of said video signal to encode at least one bit of said data into said brightness level of said video signal in a data transmission period between two row refreshing periods of said video signal.

28. An encoded video signal as claimed in claim 27 wherein said method further comprises the step of:
modulating said brightness level of said video signal using one of: bi-phase amplitude modulation and asymmetric bi-phase amplitude modulation.

29. An encoded video signal as claimed in claim 23 wherein said method further comprises the steps of:
encoding data that comprises at least one foreign language audio program into said brightness level of said video signal to create brightness modulated video images;
receiving said brightness modulated video images; and
decoding from said brightness modulated video images said data that comprises said at least one foreign language audio program.

30. An encoded video signal as claimed in claim 23 wherein said method further comprises the steps of:
encoding data that comprises an audio program for a video program for which said audio program is not audibly transmitted into said brightness level of said video signal to create brightness modulated video images;
receiving said brightness modulated video images; and
decoding from said brightness modulated video images said data that comprises said audio program for said video program for which said audio program is not audibly transmitted.
